(19) United States
(12) Patent Application Publication
(10) Pub. No.: US 2014/0053122 A1
(43) Pub. Date: Feb. 20, 2014

(54) METHOD FOR ADJUSTING A LAYOUT OF AN INTEGRATED CIRCUIT

(71) Applicants: Mango C.-T. CHAO, Hsinchu City (TW); Kuo-An CHEN, Hsinchu City (TW); Tsung-Wei CHANG, Hsinchu City (TW)

(72) Inventors: Mango C.-T. CHAO, Hsinchu City (TW); Kuo-An CHEN, Hsinchu City (TW); Tsung-Wei CHANG, Hsinchu City (TW)

(73) Assignee: NATIONAL CHIAO TUNG UNIVERSITY, Hsinchu City (TW)

(21) Appl. No.: 13/589,194

(22) Filed: Aug. 20, 2012

(51) Int. Cl. G06F 17/50

(52) U.S. Cl. 716/119

(57) ABSTRACT

A method for adjusting a layout of an integrated circuit includes a first layer, a second layer, a target metal line, and a first non-target metal line. The integrated circuit is configured for a focused ion beam (FIB) detection to the target metal line. The method includes the steps of: disposing the first non-target metal line on the first layer; disposing the target metal line on the second layer; and adjusting one of the target metal line and the first non-target metal line such that the target metal line can be detected by the FIB detection.

### BACKGROUND

1. Technical Field Disclosure

The embodiment of the present disclosure relates generally to method and, more particularly, to a method for adjusting a layout of an integrated circuit.

2. Description of Related Art

Due to the increasing complexity of modern designs and uncertainly of advanced process technologies, some design errors are difficult to detect by pure simulation during the design phase and hence are more likely to escape from the current design verification flow, which leads to a low first-silicon success rate for today's modern designs. As a result, post-silicon debug becomes a critical and necessary step in the current design flow to identify the root causes of escaped errors based on the failed silicon chips and further fix them. Therefore, the effectiveness and efficiency of the post-silicon debug will significantly affect the time and cost for achieving the design closure.

Unlike pre-silicon debug where the value of internal signals can he obtained easily through simulation, post-silicon debug has no direct access to the internal signals of a failed chip and relies on specialized circuit features or physical probing techniques to observe those internal signals. Physical probing techniques include focused ion beam techniques.

While the technology node continually and aggressively scales, the resolution of FIB techniques does not scale as fast. Thus, the percentage of nets which can be observed or repaired through FIB probing is significantly decreased for advanced process technologies, which limits the candidates that can be physically examined through the FIB techniques during the debugging process.

### SUMMARY

A method for adjusting a layout of an integrated circuit is provided to improve the fact that the percentage of nets which can be observed or repaired through FIB probing is significantly decreased for advanced process technologies.

One aspect of the embodiment of the present disclosure is to provide a method for adjusting a layout of an integrated circuit. The integrated circuit comprises a first layer, a second layer, a target metal line, and a first non-target metal line. The integrated circuit is configured for a focused ion beam (FIB) detection to the target metal line. The method comprises the steps of: disposing the first non-target metal One on the first layer; disposing the target metal line on the second layer; and adjusting one of the target metal line and the first non-target metal line such that the target metal line can be detected by the FIB detection.

In one embodiment of the present disclosure, if the first layer is disposed above the second layer, the step of adjusting one of the target metal line and the first non-target metal line comprises the steps of moving a portion of the target metal line up to the first layer such that there is no metal line which blocks the portion of the target metal line; and connecting the portion of the target metal line to the rest portion of the target metal line electrically.

In another embodiment of the present disclosure, the method for adjusting the layout of the integrated circuit further comprises a step: digging a hole from the first layer until reaching the surface of the portion of the target metal line, wherein there is no metal lines located in the hole.

In yet another embodiment of the present disclosure, the edge slope of the hole is about 1 to about 10.

In still another embodiment of the present disclosure, there is an area formed on the surface of the portion of the target metal line, and the area is defined as a baseline window. The width of the baseline window is about 1000 nm.

In yet another embodiment of the present disclosure, there is no design rule check (CRC) violation in the step of moving the portion of the target metal line up.

In still another embodiment of the present disclosure, the portion of the target metal line is not electrically connected to the first non-target metal line.

In yet another embodiment of the present disclosure, the portion of the target metal line is connected to the rest portion of the target metal line electrically through a stack via.

In still another embodiment of the present disclosure, the integrated circuit comprises a third layer and a second non-target metal line, the first, the second, and the third layers are disposed sequentially, and the first layer is the outermost layer of the first, the second, and the third layers, wherein the method comprises the steps of: disposing the second non-target metal line on the first layer, wherein the second non-target metal line is not electrically connected to the first non-target metal and moving the first non-target metal line down to the third layer such that there is no metal line which blocks the entire target metal line.

In one embodiment of the present disclosure, if the first layer is disposed above the second layer, the step of adjusting one of the target metal line and the first non-target metal line comprises the step of: adjusting the target metal line to the lateral side of the original target metal line such that there is no metal line which blocks the entire target metal line.

As a result, the embodiments of the present disclosure provide a method for adjusting a layout of an integrated circuit to improve the fact that the percentage of nets which can be observed or repaired through FIB probing is significantly decreased for advanced process technologies.

Compared with the prior art, performing the method for adjusting a layout of an integrated circuit of the embodiment of the present invention can successfully increase the FIB observable rate from 29.50% to 61.67% in average. In addition, the timing after applying the method far adjusting a layout of an integrated circuit of embodiment of the present disclosure can indeed becomes faster than the timing of its initial layout.

### BRIEF DESCRIPTION OF THE DRAWINGS

The disclosure can be more fully understood by reading the following to detailed description of the embodiments, with reference made to the accompanying drawings as follows:

FIG. 1A schematically shows a surface milling operation diagram of focused ion beam (FIB) process according to prior art.

FIG. 1B schematically shows a deposition operation diagram of FIB process according to prior art.

FIG. 2A schematically shows a top view of a hole formed by FIB process according to prior art.

FIG. 2B schematically shows a cross-section view of the hole formed by FIB process according to prior art.

FIG. 3 schematically shows a table of FIB observable rates according to prior art.

FIG. 4A schematically shows a layout diagram of an integrated circuit according to embodiments of the present disclosure.

FIG. 4B schematically shows a layout diagram of an integrated circuit after applying a move-up operation thereto according to embodiments of the present disclosure.

FIG. 4C schematically shows a flow diagram of a method for adjusting a layout of an integrated circuit according to embodiments of the present disclosure.

FIG. 5A schematically shows a layout diagram of an integrated circuit to according to embodiments of the present disclosure.

FIG. 5B schematically shows a layout diagram of an integrated circuit after applying a move-down operation thereto according to embodiments of the present disclosure.

FIG. 5C schematically shows a flow diagram of a method for adjusting a is layout of an integrated circuit according to embodiments of the present disclosure.

FIG. 6A schematically shows a layout diagram of an integrated circuit according to embodiments of the present disclosure.

FIG. 6B schematically shows a layout diagram of an integrated circuit after applying a move-side operation thereto according to embodiments of the present disclosure.

FIG. 6C schematically shows a flow diagram of a method for adjusting a layout of an integrated circuit according to embodiments of the present disclosure.

FIG. 7A schematically shows a layout diagram of an integrated circuit according to embodiments of the present disclosure.

FIG. 7B schematically shows a layout diagram of an integrated circuit after applying a move-up and move-down operation thereto according to embodiments of the present disclosure.

FIG. 8 schematically shows a table of FIB observable rates according to to embodiments of the present disclosure.

FIG. 9 schematically shows a table of longest-path delay before and after applying a move-up operation, a move-down operation, a move-side operation, or combination thereof to a layout of an integrated circuit according to embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around,” “about” or “approximately” shall generally is mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

Before proceeding further, it is appropriate to introduce focused ion beam (FIB) technology. A FIB systems operates in a similar manner as a scanning electron microscope (SEM) or a transmission electron microscope (TEM) except that the FIB system utilizes a focused beam of ion (for example, gallium) instead of electrons. When operating at a low beam current, a focused ion beam can be used for imaging the sample surface with high resolution. When operating at a high beam current, a focused ion beam can be used for milling the surface.

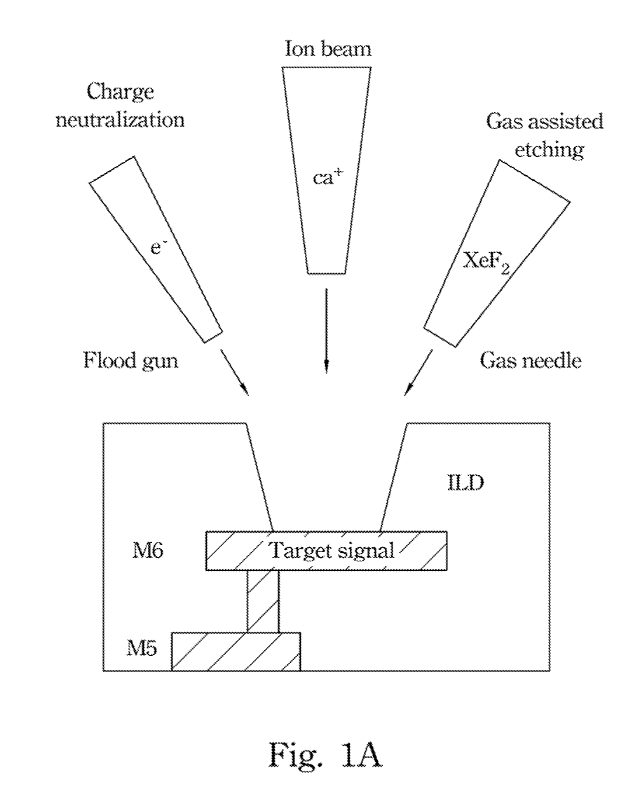

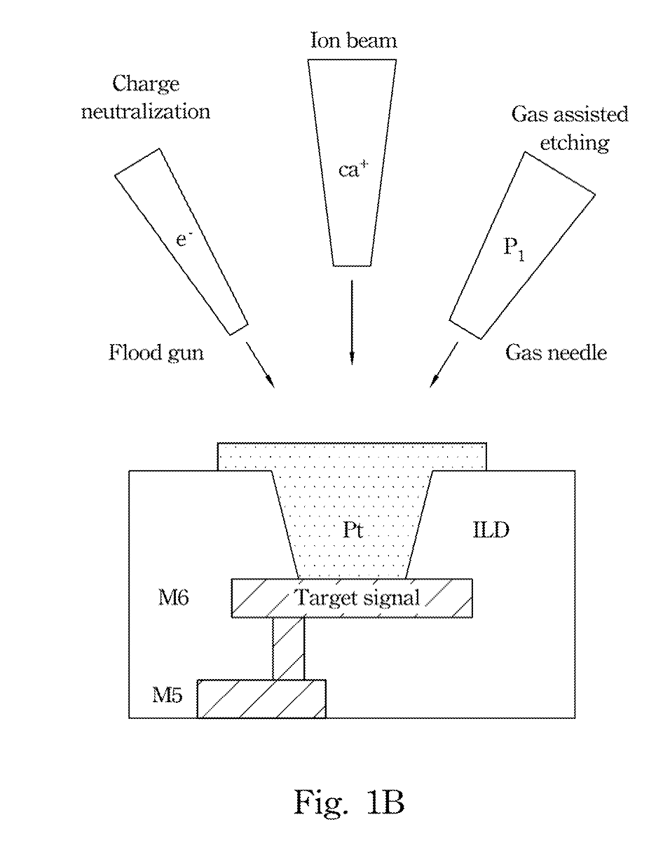

FIG. 1A schematically shows a surface milling operation diagram of focused ion beam (FIB) process according to prior art. As shown in FIG. 1A, it illustrates an example of using. FIB technique to observe a target signal inside a chip. A surface milling operation is performed by applying a focused ion beam of Ga+ to hit the surface of inter-layer dielectric (ILD), break the bonds of a certain amount of surface material, sputter out ions (for example, positive ions), and gradually form a hole right above the target signal. Meanwhile, an electron beam is applied to the surface to neutralize the sputtered positive ions, and sometimes certain gas (for example, XeF2) is also applied to assist the etching.

Subsequently, FIG. 1B schematically shows a deposition operation diagram of FIB process according to prior art. In FIG. 1B, FIB is used to deposit metal (for example, Pt) onto the dug hole. When the ion beam hits the gas of metal, the metal will chemisorb on the surface through FIB-assisted chemical vapor deposition. The deposition of metal then forms a probe pad for the target signal.

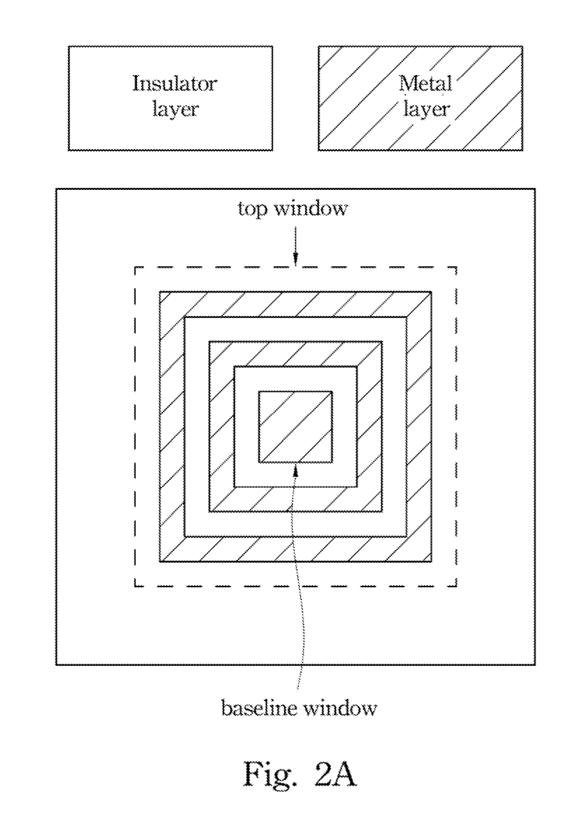

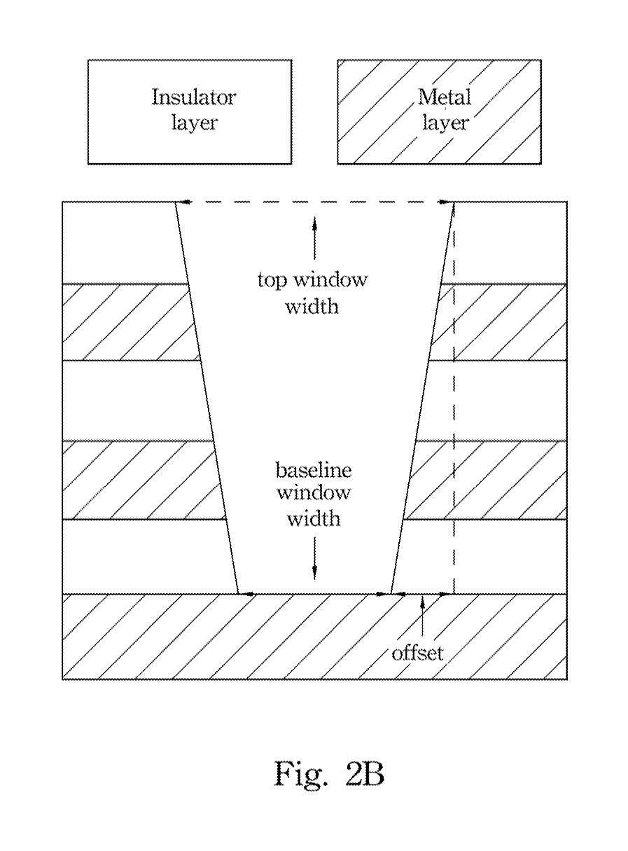

In order to successfully perform an FIB probe or FIB circuit editing, the area of the bottom of the FIB-dug hole, defined as baseline window, needs to be large enough. The larger the baseline window is, the higher the probability of a successful FIB action will be. Since the focused ion beam or its reflection from the surface may also hit the edge of the dug hole during the surface milling, the edge of the dug hole is not directly orthogonal to the baseline window but a few angels outward from bottom to top, as illustrated in FIGS. 2A and 2B which schematically show a top view and a cross-section view of the dug hole formed by FIB process according to prior art.

As a result, for each higher metal layer, the width of its transverse section with the dug hole is an offset larger. In other words, if there is a need to dig a hole to a lower metal layer, the area saved for the top of the hole, defined as top window, needs to be larger even though the required size of the baseline window is the same for all metal layers.

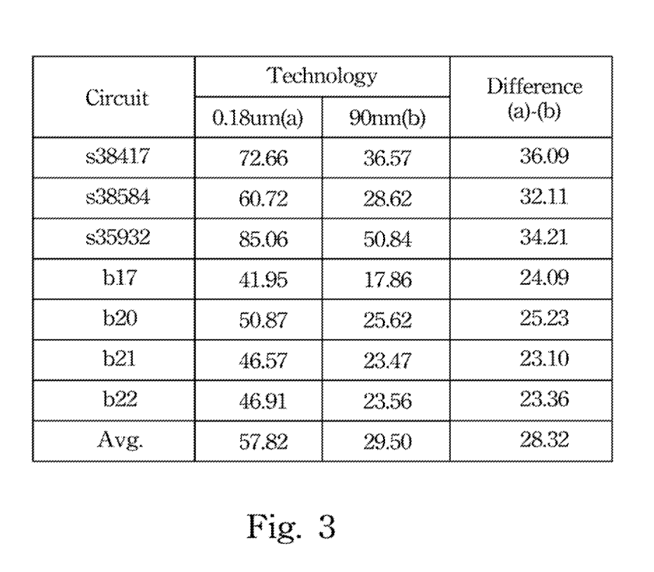

FIG. 3 schematically shows a table of FIB observable rates according to prior art. As shown in FIG. 3, there are percentage of the total nets which can be successfully observed by FIB probing, for the benchmark circuits implemented by a UMC 0.18 um and a UMC 90 nm process technology, respectively. The layout of each circuit is generated by a commercial back-end tool, SoC Encounter, with a 80% cell-utilization rate. The benchmark circuits in use are the relatively large circuits selected from the ISCAS and ITC benchmarks.

As can be seen in FIG. 3, the average of the FIB observable rate is 57.82% for benchmark circuits implemented by the 0.18 um technology, and drops to only 29.50% for that by the 90 nm technology. The FIB observable rate will be even worse if a 65 nm or 40 nm technology is used. In other words, more than 70% of a circuit's nets cannot be observed by FIB probing if a 90 nm or smaller technology is used, which significantly limits the candidates that can be diagnosed through the FIB techniques and may delay the overall silicon-debug or failure-analysis process.

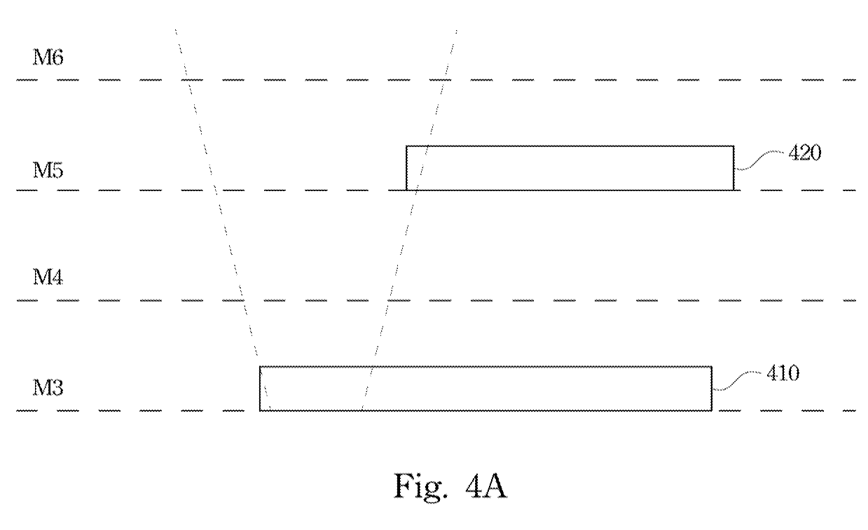

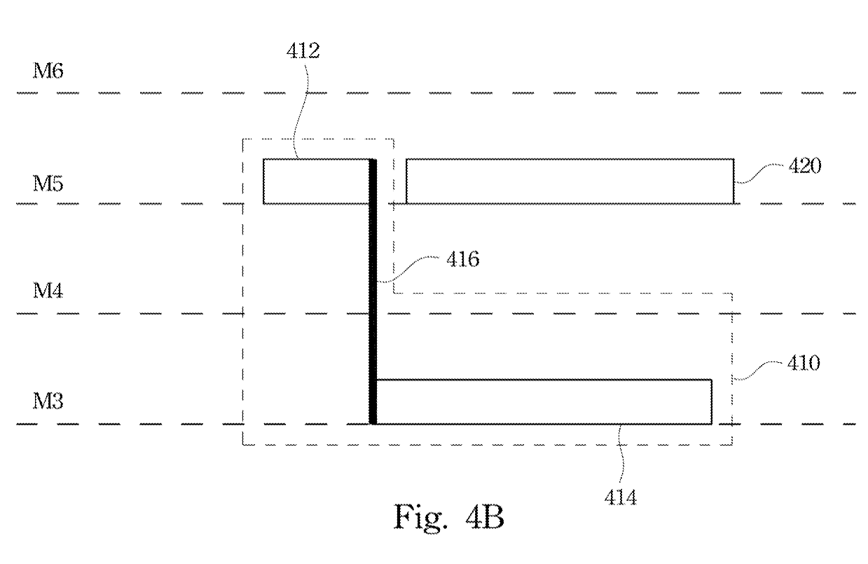

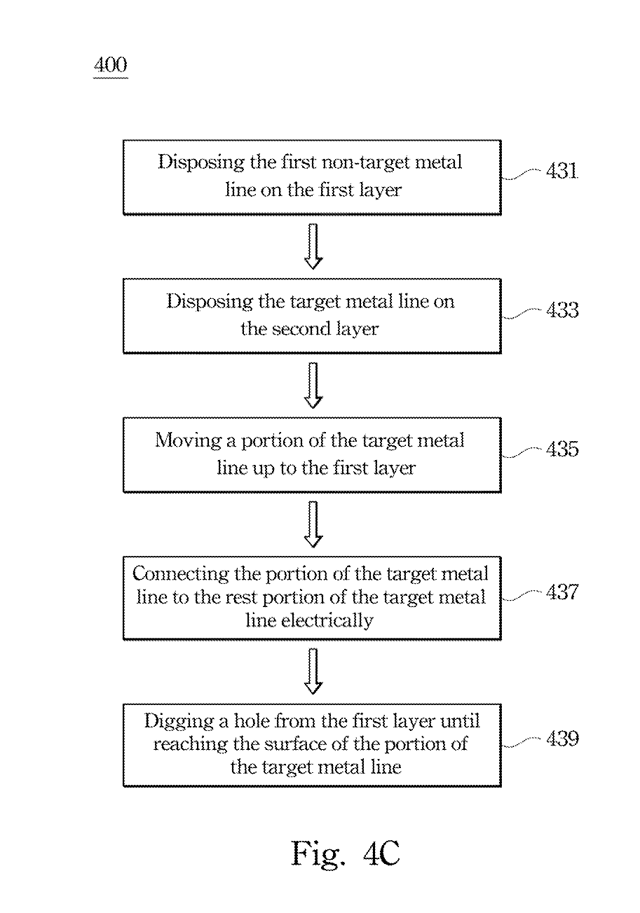

The present invention discloses an improvement for the FIB technique as described above. FIG. 4A schematically shows a layout diagram of an integrated circuit according to embodiments of the present disclosure. As illustrated in FIG. 4A, a target metal line 410 is blocked by a non-target metal line 420 such that the target metal line 410 cannot be detected by FIB probing. In other words, this configuration results in a fact that there is no change to dig a sufficient hole for FIB probing to the target metal line 410. One embodiment of the present invention provides a method for adjusting the layout of the integrated circuit, which is shown in FIG. 4B, defined as a move-up operation, to improve such situation.

FIG. 4B schematically shows a layout diagram of an integrated circuit after applying a move-up operation thereto according to embodiments of the present disclosure. Compared with FIG. 4A, FIG. 4B shows that a portion 412 of the target metal line 410 has been moved up from the metal layer M3 to the metal layer M5, and the portion 412 of the target metal line 410 is connected to the rest portion 414 of the target metal line 410 electrically through a stack via 416. Therefore, there is no metal line above the portion 412 of the target metal line 410, and the target metal line 410 can be detected by FIB probing.

In one embodiment of the present invention, if digging a hole from the first layer for example, the metal layer M5) until reaching the surface of the portion 412 of the target metal line 410, there is no metal line located in the hole, so the target metal line 410 can be detected directly by FIB probing without any interference from other metal lines such as the non-target metal line 420.

For example, the edge slope of the hole is about 1 to about 10. There is an area formed on the surface of the portion 412 of the target metal line 410, and the area is defined as a baseline window, wherein the width of the baseline window is about 1000 nm, However, the embodiment of the present disclosure is not intended to be limited in this regard, and these examples are provided for illustration purposes only to represent different possible implementations of the present disclosure.

As can be seen in FIG. 4B, the portion 412 of the target metal line 410 is not electrically connected to the non-target metal line 420. Furthermore, there is no design rule check (DRC) violation in said move-up operation.

Substantially, the steps of the move-up operation are as mentioned below in FIG. 4C, which schematically shows a flow diagram of a method for adjusting a layout of an integrated circuit according to embodiments of the present disclosure.

With respected to the configuration, the integrated circuit comprises a first layer, a second layer, a target metal line, and a first non-target metal line, and the integrated circuit is configured for a focused ion beam (FIB) detection to the target metal line.

As shown in FIG. 4C, the method 400 for adjusting the layout of the integrated circuit, which is defined as a move-up operation, comprises the steps of: disposing the first non-target metal line on the first layer (step 431); disposing the target metal line on the second layer (step 433); moving a portion of the target metal line up to the first layer such that there is no metal line which blocks the portion of the target metal line (step 435); connecting the portion of the target metal line to the rest portion of the target metal line electrically (step 437); and digging a hole from the first layer until reaching the surface of the portion of the target metal line, wherein there is no metal line located in the hole (step 439).

Reference is now made to both FIGS. 4A and 4C. In step 431, the first non-target metal line such as the metal line 420 is disposed on the first layer such as the metal layer M5. Referring to step 433, the target metal line such as the metal line 410 is disposed on the second layer such as the metal layer M3.

With respected to both FIGS. 4B and 4C. In step 435, the portion of the target metal line such as the portion 412 is moved up to the first layer M5 such that there is no metal line which blocks the portion 412 of the target metal line 410. In step 437, the portion 412 of the target metal line 410 is connected to the rest portion of the target metal line such as the rest portion 414 electrically. Furthermore, referring to step 439, a hole is made by digging from the first layer M5 until reaching the surface of the portion 412 of the target metal line 410, wherein there is no metal line located in the hole.

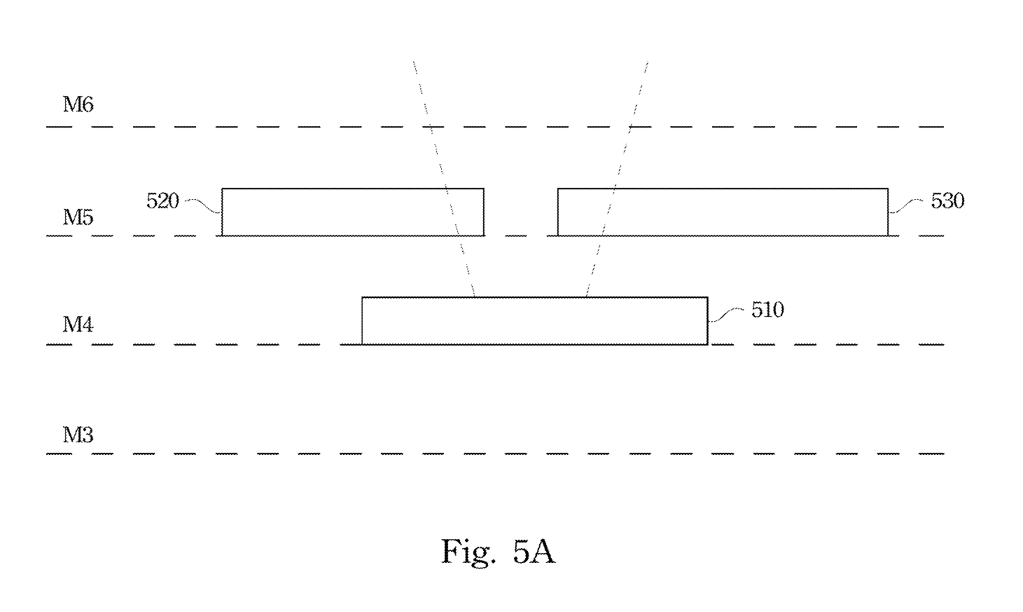

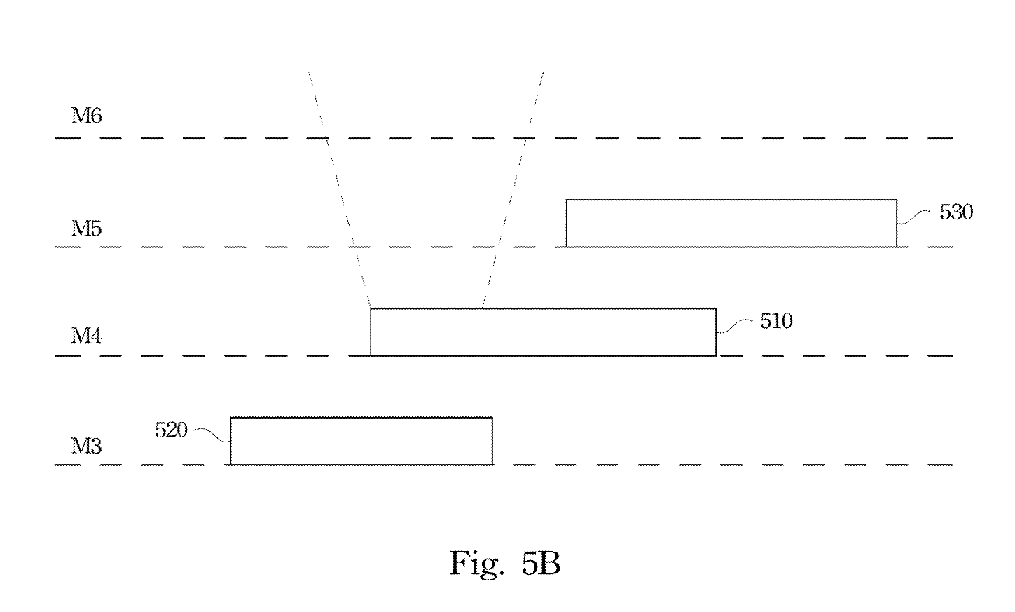

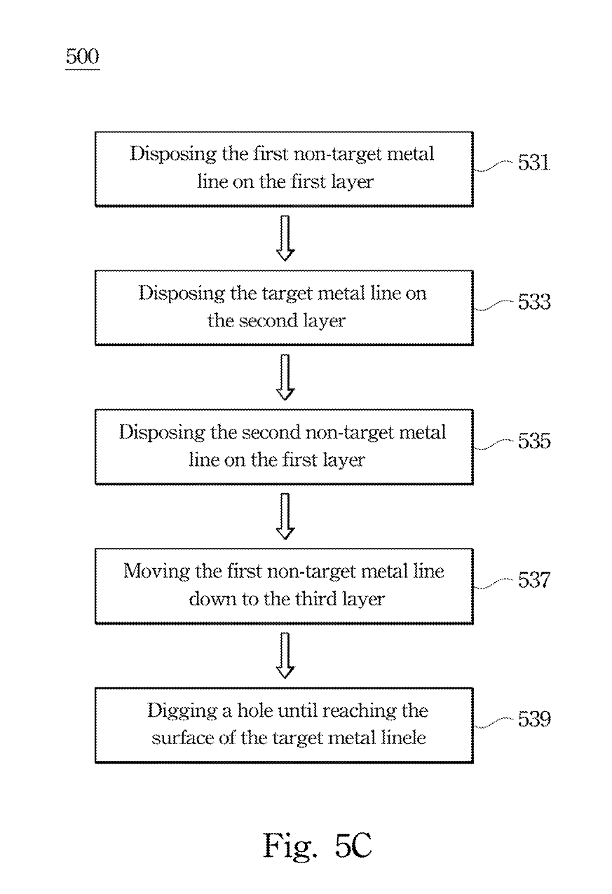

FIG. 5A schematically shows a layout diagram of an integrated circuit according to embodiments of the present disclosure. As illustrated in FIG. 5A, a target metal line 510 is blocked by non-target metal lines 520, 530 such that the target metal line 510 cannot be detected by FIB probing. In other words, this configuration results in a fact that there is no change to dig a sufficient hole for FIB probing. One embodiment of the present invention provides a method for adjusting the layout of the integrated circuit, which is shown in FIG. 5B, defined as a move-down operation, to improve such situation.

FIG. 5B schematically shows a layout diagram of an integrated circuit after applying a move-down operation thereto according to embodiments of the present disclosure. Compared with FIG. 5A, FIG. 5B shows that the non-target metal line 530 has been moved down from the metal layer M5 to the metal layer M3, such that there is no metal line above the target metal line 510, and the target metal line 510 can be detected by FIB probing.

In one embodiment of the present invention, if digging a hole until reaching the surface of the target metal line 510, there is no metal line located in the hole, so the target metal line 510 can be detected directly by FIB probing without any interference from other metal lines such as the non-target metal lines 520, 530.

For example, the edge slope of the hole is about 1 to about 10. There is an area formed on the surface of the target metal line 510, and the area is defined as a baseline window, wherein the width of the baseline window is about 1000 nm. As can be seen in FIG. 5B, there is no design rule check (DRC) violation in the move-down operation. However, the embodiment of the present disclosure is not intended to be limited in this regard, and these examples are provided for illustration purposes only to represent different possible implementations of the present disclosure.

Substantially, the steps of the move-down operation are as mentioned below in FIG. 5C, which schematically shows a flow diagram of a method for adjusting a layout of an integrated circuit according to embodiments of the present disclosure.

With respected to the configuration, the integrated circuit comprises a first layer, a second layer, a third layer, a target metal line, a first non-target metal line, and a second non-target metal line. The first, the second, and the third layers are disposed sequentially, and the first layer is the outermost layer of the first, the second and the third layers.

As shown in FIG. 5C, the method 500 for adjusting the layout of the integrated circuit, which is defined as a move-down operation, comprises the steps of: disposing the first non-target metal line on the first layer (step 531); disposing the target metal line on the second layer (step 533); disposing the second non-target metal line on the first layer, wherein the second non-target metal line is not electrically connected to the first non-target metal line (step 535); moving the first non-target metal line down to the third layer such that there is no metal line which blocks the entire target metal line (step 537); and digging a hole until reaching the surface of the target metal line, wherein there is no metal line located in the hole (step 539).

With respected to both FIGS. 5A and 5C. In step 531, the first non-target metal line such as the metal line 530 is disposed on the first layer such as the metal layer M5. Referring to step 533, the target metal line such as the metal line 510 is disposed on the second layer such as the metal layer M4. In step 535, the second non-target metal line such as the metal line 530 is disposed on the first layer M5, wherein the second non-target metal line 530 is not electrically connected to the first non-target metal line 520.

Reference is now made to both FIGS. 5B and 5C. In step 537, the first non-target metal line 520 is moved down to the third layer such as the metal layer M3 such that there is no metal line which blocks the entire target metal line 510. Referring to step 539, a hole is made by digging until reaching the surface of the target metal line 510, wherein there is no metal line located in the hole.

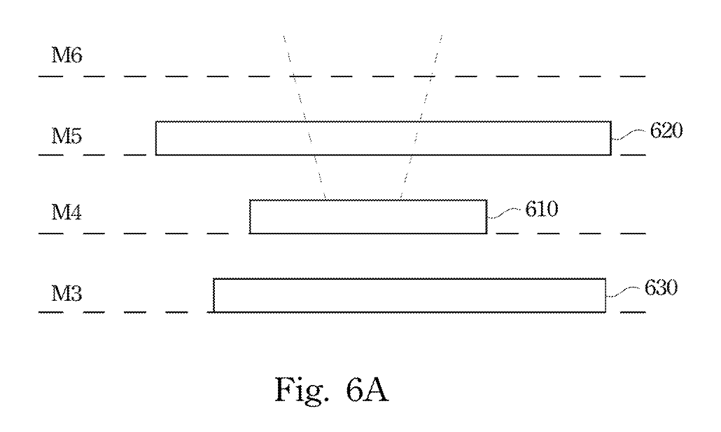

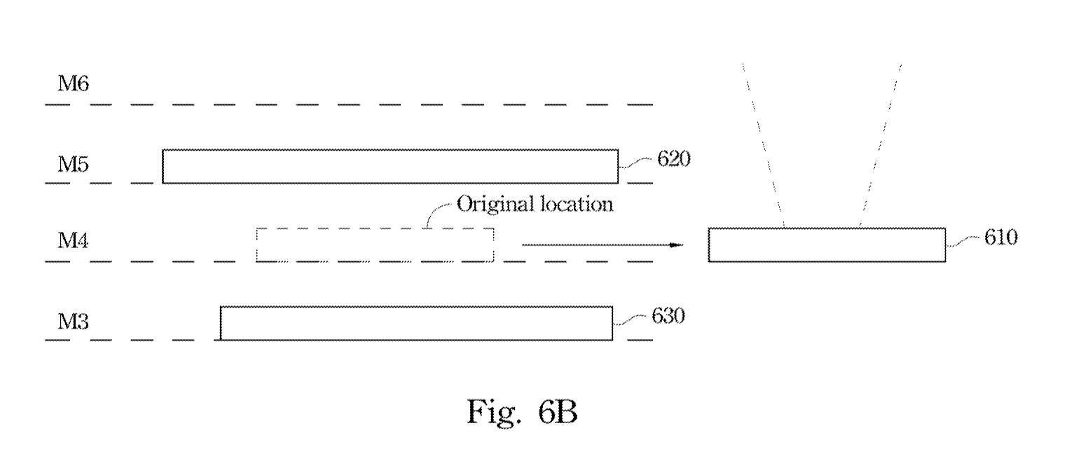

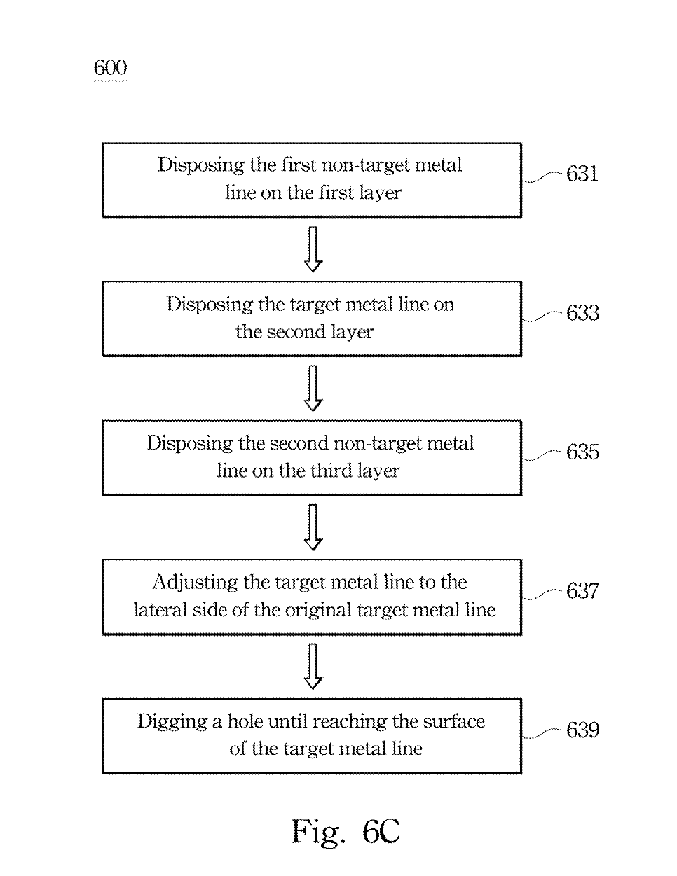

FIG. 6A schematically shows a layout diagram of an integrated circuit according to embodiments of the present disclosure. As illustrated in Figure GA, a target metal line 610 is blocked by a non-target metal line 620 such that the target metal line 610 cannot be detected by FIB probing. In this situation, the move-down operation cannot be performed due to there being a non-target metal line 630 below the target metal line 610. In other words, this configuration results in a fact that there is no change to dig a sufficient hole for FIB probing. One embodiment of the present invention provides a method for adjusting the layout of the integrated circuit, which is shown in Figure GB, defined as a move-side operation, to improve such situation.

FIG. 6B schematically shows a layout diagram of an integrated circuit after applying a move-side operation thereto according to embodiments of the present disclosure. Compared with FIG. 6A, FIG. 6B shows that the target metal line 610 has been moved from the original location to lateral side thereof such that there is no metal line above the target metal line.

In one embodiment of the present invention, if digging a hole until reaching the surface of the target metal line 610, there is no metal line located in the hole, so the target metal line 610 can be detected directly by FIB probing without any interference from other metal lines such as the non-target metal line 620, 630.

For example, the edge slope of the hole is about 1 to about 10. There is an area formed on the surface of the target metal line 610, and the area is defined as a baseline window, wherein the width of the baseline window is about 1000 nm. As can be seen in FIG. 6B, there is no design rule check (DRC) violation in the move-side operation. However, the embodiment of the present disclosure is not intended to be limited in this regard, and these examples are provided for illustration purposes only to represent different possible implementations of the present disclosure.

Substantially, the steps of the move-sidw operation are as mentioned below in FIG. 6C, which schematically shows a flow diagram of a method for adjusting a layout of an integrated circuit according to embodiments of the present disclosure.

With respected to the configuration, the integrated circuit comprises a first layer, a second layer, a third layer, a target metal line, a first non-target metal line, and a second non-target metal line. The first, the second, and the third layers are disposed sequentially, and the first layer is the outermost layer of the first, the second, and the third layers.

As shown in FIG. 6C, the method 600 for adjusting the layout of the integrated circuit, which is defined as a move-side operation, comprises the steps of disposing the first non-target metal line on the first layer (step 631); disposing the target metal line on the second layer (step 633); disposing the second non-target metal line on the third layer (step 635), adjusting the target metal line to the lateral side of the original target metal line such that there is no metal line which blocks the entire target metal line (step 637), and digging a hole until reaching the surface of the target metal line, wherein there is no metal line located in the hole (step 639).

Reference is now made to both FIGS. 6A and 6C. In step 631, the first non-target metal line such as the metal line 620 is disposed on the first layer such as the metal layer M5. Referring to step 633, the target metal line such as the metal line 610 is disposed on the second layer such as the metal layer M4. In step 635, the second non-target metal line such as the metal line 630 is disposed on the third layer such as the metal layer M3.

With respected to both FIGS. 6B and 6C. In step 637, the target metal line 610 is adjusted to the lateral side of the original target metal line such that there is no metal line which blocks the entire target metal line 610. Referring to step 639, a hole is made by digging until reaching the surface of the target metal line 610, wherein there is no metal line located in the hole.

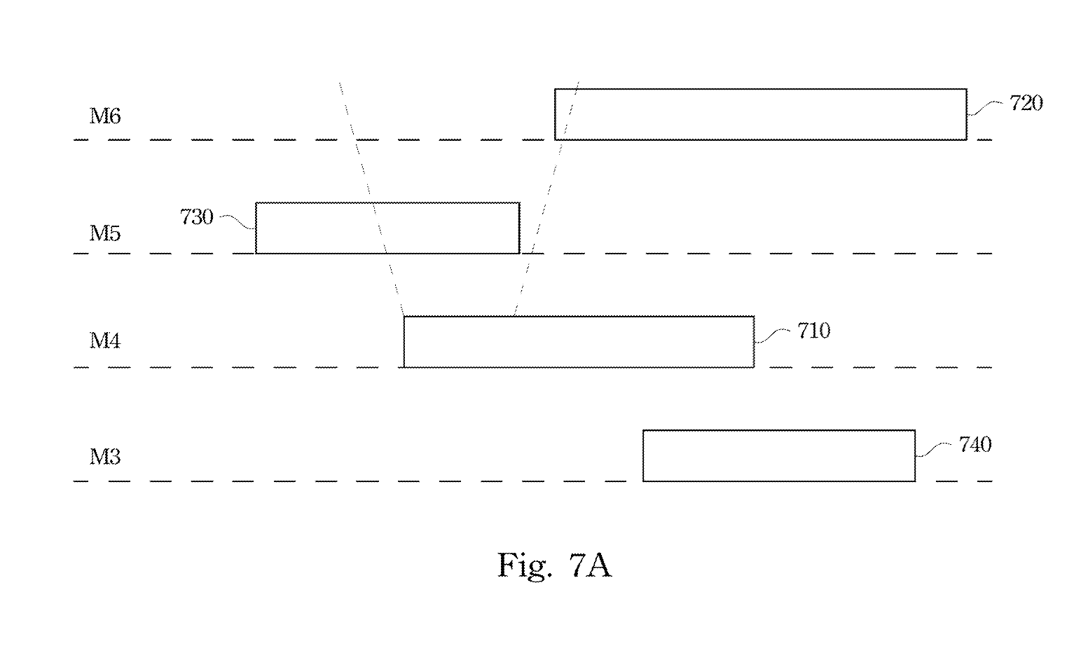

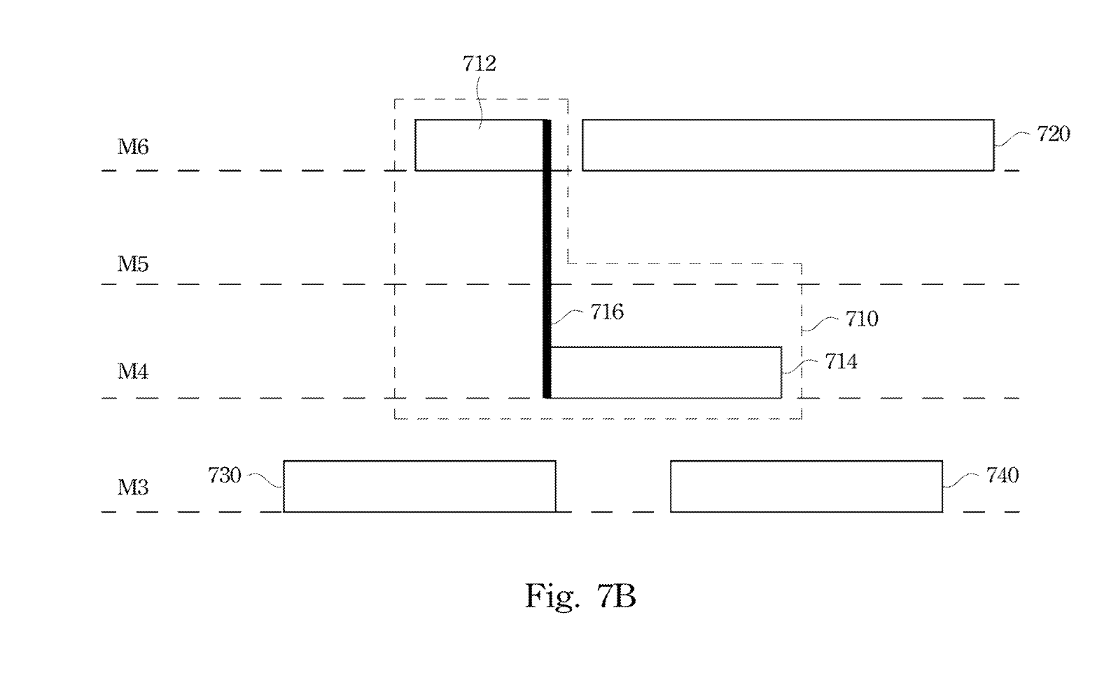

FIG. 7A schematically shows a layout diagram of an integrated circuit according to embodiments of the present disclosure. In the situation illustrated in the FIG. 7A, a target metal line 710 is blocked by non-target metal lines 720, 730. In such situation, a single move-down operation for non-target metal line 730 cannot solve the problem due to the fact that if digging a hole from the metal layer M6 to the surface of the target metal line 710, there is another non-target metal line in the hole such as the non-target metal line 720, and FIB probing to the target metal line 710 will be interfered by the non-target metal line 720.

For solving the problem existing in FIG. 7A, there is an operation set forth in FIG. 78, which schematically shows a layout diagram of an integrated circuit after applying a move-up and move-down operation thereto according to embodiments of the present disclosure. Compared with FIG. 7A, FIG. 78 shows that the non-target metal line 730 has been moved down from the metal layer M5 to the metal layer M3, and then a portion 712 of the target metal line 710 is moved up from the metal layer M4 to the metal layer M6. The portion 712 of the target metal line 710 is connected to the rest portion 714 of the target metal line 710 electrically through a stack via 716. Therefore, there is no metal line above the portion 712 of the target metal line 710, and the target metal line 710 can be detected by FIB probing.

In one embodiment of the present invention, if digging a hole until reaching the surface of the portion 712 of the target metal line 710, there is no metal line located in the hole, so the target metal line 710 can be detected directly by FIB probing without any interference from other metal lines such as the non-target metal lines 720, 730, 740.

For example, the edge slope of the hole is about 1 to about 10. There is an area formed on the surface of the portion 712 of the target metal line 710 and the area is defined as a baseline window, wherein the width of the baseline window is about 1000 nm. However, the embodiment of the present disclosure is not intended to be limited in this regard, and these examples are provided for illustration purposes only to represent different possible implementations of the present disclosure.

As can be seen in FIG. 7B, the portion 712 of the target metal line 710 is not electrically connected to the non-target metal line 720. Furthermore, there is no design rule check (DRC) violation in the move-up and move-down operation.

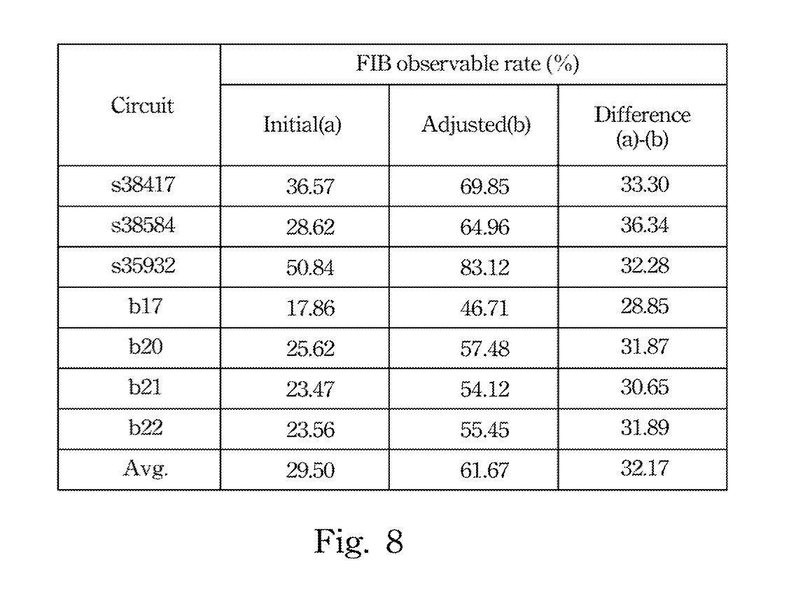

FIG. 8 schematically shows a table of FIB observable rates according to embodiments of the present disclosure. The table illustrates the FIB observable rate before and after performing the method for adjusting a layout of an integrated circuit such as move-up operation, move-down operation, move-side operation, or the combination thereof to a layout of an integrated circuit. The layout of each circuit is generated with a 80% cell-utilization rate.

As the result shown in the table, performing the method for adjusting a layout of an integrated circuit of the embodiment of the present invention can successfully increase the FIB observable rate from 29.50% to 61.67% in average. The improvement in FIB observable rate ranges from 28.85% to 36.34% for different circuits. It is noteworthy that the above-mentioned average 61.67% of the FIB observable rate already exceeds the average FIB observable rate of the benchmark circuits implemented by a 0.18 um process (57.82%) with the same cell utilization rate.

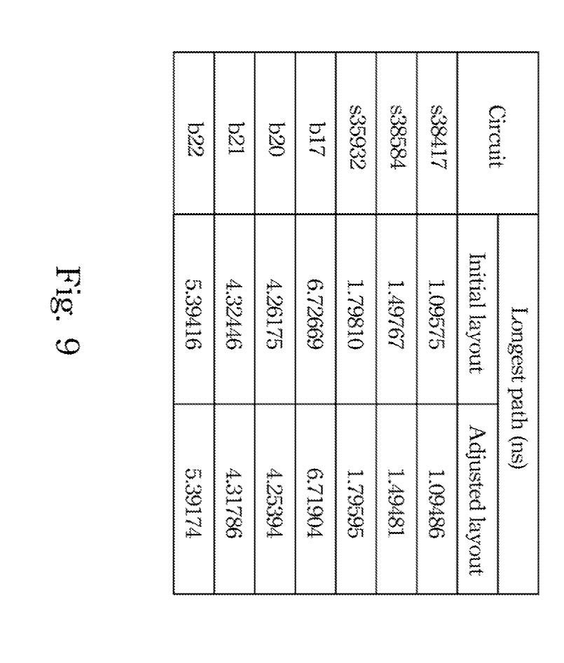

Reference is now ade to FIG. 9, which schematically shows a table of longest-path delay before and after applying a move-up operation, a move-down operation, a move-side operation, or combination thereof to a layout of an integrated circuit according to embodiments of the present disclosure. Even through a move-up operation, a move-down operation, a move-side operation, or combination thereof may add extra stick vias to a net, which increases its resistance, the circuit's timing after applying the operations as mentioned above usually becomes faster than its initial layout. FIG. 9 lists the longest path delay before and after applying the operations as mentioned above, which is reported by a commercial timing analysis tool with the result of layout RC extraction, As shown in FIG. 9, the timing after applying said operations can indeed become faster than the timing of its initial layout for every benchmark circuit. Also, every modified layout passes the connection checking and equivalence checking.

This faster timing of the modified layout results from the following two reasons. First, the long delay of a critical path usually results from the large coupling capacitance affected by the long paralleled metal lines in its neighborhood. Fortunately, said operations often move only a portion of a metal line to another layer, which can reduce the overlapping length of the paralleled lines and in turn reduce the coupling capacitance. Second, for most CMOS technologies, the unit-length capacitance of the metal on a higher layer is smaller than that on a lower layer. in one embodiment of the present invention, a move-up operation is performed more often than a move-down operation, meaning that the metal used on higher layers becomes more after the layout adjustment. As a result, the overall metal capacitance usually decreases and so does the timing of the circuit.

Those having skill in the art will appreciate that the method for adjusting a layout of an integrated circuit can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method for adjusting a layout of an integrated circuit named after the function thereof is merely used to describe the technology in the embodiment of the present disclosure in detail but not limited to. Therefore, combining the steps of said method into one step, dividing the steps into several steps, or rearranging the order of the steps is within the scope of the embodiment in the present disclosure.

In view of the foregoing embodiments of the present disclosure, many advantages of the present disclosure are now apparent. The embodiment of the present disclosure provides a method for adjusting a layout of an integrated circuit to improve the fact that the percentage of nets which can be observed or repaired through FIB probing is significantly decreased for advanced process technologies.

Compared with the prior art, performing the method for adjusting a layout of an integrated circuit of the embodiment of the present invention can successfully increase the FIB observable rate from 29.50% to 61.67% in average. In addition, the timing after applying the method for adjusting a layout of an integrated circuit of embodiment of the present disclosure can indeed becomes faster than the timing of its initial layout.

It will be understood that the above description of embodiments is given by way of example only and that various modifications may be made by those with ordinary skill in the art. The above specification, examples and data provide a complete description of the structure and use of exemplary embodiments of the disclosure. Although various embodiments of the disclosure have been described above with a certain degree of particularity, or with reference to one or more individual embodiments, those with ordinary skill in the art could make numerous alterations to the disclosed embodiments without departing from the spirit or scope of this disclosure, and the scope thereof is determined by the claims that follow.

1. A method for adjusting a layout of an integrated circuit, wherein the integrated circuit comprises a first layer, a second layer, a target metal line, and a first non-target metal line, and the integrated circuit is configured for a focused ion team (FIB) detection system to detect the target metal line, wherein the method comprises:
disposing the first non-target metal line on the first layer;
disposing the target metal line on the second layer; and
adjusting first non-target metal line, wherein the FIB detection system detects the target metal line.

2. (canceled)

3. The method according to claim 1, further comprising:
digging a hole from the first layer until reaching the surface of the portion of the target metal line, wherein there is no metal line located in the hole.

4. (canceled)

5. (canceled)

6. (canceled)

7. (canceled)

8. (canceled)

9. The method according to claim 1, wherein the integrated circuit comprises a third layer and a second non-target metal line, the first, the second, and the third layers are disposed sequentially, and the first layer is the outermost layer of the first, the second, and the third layers, wherein the method further comprises:
disposing the second non-target metal line on the first layer, wherein the second non-target metal line is not electrically connected to the first non-target metal line;
wherein the step of adjusting the first non-target metal line comprises:
moving the first non-target metal line down to the third layer such that here is no metal line which blocks the entire target metal line.

10. The method according to claim 9, further comprising:
digging a hole until reaching the surface of the target metal line, wherein there is no metal line located in the hole.

11. (canceled)

12. The method according to claim 10, wherein there is an area formed on the surface of the portion of the target metal line, and the area is defined as a baseline window, wherein the width of the baseline window is about 1000 nm.

13. The method according to claim 9, wherein there is no DRC violation in the step of moving the first non-target metal line down.

14.-18. (canceled)
